(19) United States
(12) Patent Application Publication
(10) Pub. No.: US 2002/0150035 A1
(43) Pub. Date: Oct. 17, 2002

(54) Near-field optical recording system employing a monolithic read/write head

(75) Inventors: Bruce E. Bernacki, Winter Springs, FL (US); Kristin A.M. Scott, Ogden, UT (US); Christopher D. Hahm, Roy, UT (US); Paul R. Johnson, Kaysville, UT (US)

Correspondence Address: Michael J. Swope, WOODCOCK WASHBURN KURTZ, MACKIEWICZ & NORRIS LLP, One Liberty Place - 46th Floor, Philadelphia, PA, 19103, US

(73) Assignee: Iomega Corporation

(21) Appl. No.: 09/837,313

(22) Filed: Apr. 17, 2001

(51) Int. Cl. G11B 7/00; G11B 15/64; G11B 17/32

(52) U.S. Cl. 369/300

(57) ABSTRACT

An optical storage device that is characterized by an actuator assembly movably coupled within said optical information storage apparatus. A narrow buried heterojunction semiconductor laser is coupled to a distal end of the arm so that the arm moves the narrow buried heterojunction semiconductor laser into a near field relationship with an optical medium. A motor spins the optical medium at an operational speed.

### BACKGROUND OF THE INVENTION

This invention is directed to optical data storage; more specifically, it is directed to an optical data storage device that employs a semiconductor laser read/write head.

Various types of devices that read and write information on a rotating disk medium have been developed and used for some time as computer data storage devices. For example, widely used magnetic disk drive devices are generally available in two broad categories-removable and fixed. In particular, removable cartridge disk drives read and write information magnetically on a disk that is enclosed in a removable protective case. By contrast, fixed disk drives read and write information magnetically on a fixed disk that is permanently fixed in the data storage device.

Data storage needs are constantly growing as the type and variety of content continues to increase in both computer and other non-computer digital storage arenas. Magnetic storage continues to grow to meet the demand, although mainly in the non-removable area. The ultimate limit, as seen today, lies in the super-paramagnetic limit of currently-known in-plane magnetic storage materials. This limit has to do with the minimum stable domain that can be written in particulate magnetic storage media. Optical materials, either magneto-optical (which is amorphous magnetic material with perpendicular anisotropy) or phase change have upper storage limits that exceed the currently-understood paramagnetic limit. The limits of optical storage media have been probed experimentally with optical and other scanning probe microcopies to determine minimum domain or mark sizes to confirm this density advantage. However, even if storage densities were roughly equal between magnetic and optical storage media, optical media has an advantage with respect to replication for both servo and disk preformatting as well as distribution of content, e.g., software, data, movies. Thus, both read-only as well as user-writeable approaches are possible with optical storage media, which sets optical storage media apart from magnetic storage media.

Conventional optical storage drive mechanisms comprise a laser diode, a collimator, a beam shaping anamorphic prism pair, beam splitters for power monitoring and servo and data detection, focusing lenses, and a servo and data detection optical path. The servo and data paths are usually combined to make efficient use of light reflected from the disk. Since these functions require discrete optical components that must be hand assembled by skilled workers, optical read/write drives continue to be relatively expensive compared with magnetic drives. Also, in optical drives, the maximum density is limited by the size of the optical spot formed by the optical stylus. Classical physical optics theory shows that spot size is proportional to λ/N.A., where λ is the wavelength of the light source, and N.A. is the numerical aperture of the focusing lens. Numerical aperture is defined as the sine of the angular semi-aperture in object space of the lens multiplied by the index of refraction in object space. N.A. is a convenient metric in optical data storage since the greater the N.A., the larger the resolving power of the objective (as well as having greater light-gathering power), which translates to a smaller spot size and higher storage density.

Conventional optical disk drives are complex and have areal densities limited by the wavelength of currently-available laser diodes, as well as the value of the N.A. that can be tolerated in a focusing objective. Numerical aperture is limited by several factors: 1) the working distance from the lens to the active layer of the media, which can be limited by the protective substrate thickness, 2) maximum allowable tilt of the disk, which effects the degree of aberration and failure to obtain minimum attainable spot size, and 3) the mechanical response of the focus servo, which depends on the depth of focus of the lens. Since depth of focus is proportional to λ/(N.A.²), the N.A. cannot be increased without limit since its influence is a second order effect. Working distance is also related to the N.A. of the focusing objective, which can also be limited by the thickness of protective substrate required. So, optical materials technology and semiconductor laser development bound the practical wavelength limit, and mechanical limitations of the drive/media system bound the highest N.A. that can be employed successfully in conventional optical data disk drives.

U.S. Pat. No. 4,860,276, which is assigned to Nippon Telegraph and Telephone (NTT) proposes a solution to the complexity of optical head assemblies that employs an optical stylus that functions like a conventional thin-film magnetic head. The NTT approach combines easy-to-manufacture functions of reading and writing in single light-weight element. Briefly, the NTT approach uses a tapered waveguide semiconductor laser to limit the lateral extent of the optical stylus and thereby form a relatively small spot on the media. This method exploits the optical feedback into the laser diode as the data detection method, and was dubbed an Optically Switched Laser (OSL) head. However, this embodiment is limited to phase change type optical materials. Also, the taper width of the laser structure (and hence, minimum spot size on the media surface) depends directly on currently-available photolithography limits. Therefore, the lateral extent cannot exceed the limits of state-of-the-art optical lithography and controlled etching procedures which impacts yield and the ultimate cost of this approach. Also, no secondary actuator is described to enable high speed track following such as currently employed in optical drives to permit both linear density and increased radial density.

U.S. Pat. No. 5,286,971 discloses a method of purportedly achieving wavelength-independence. The method disclosed therein shines light through an aperture in close proximity to the surface of interest (spacing ≦λ/2) with the aperture having lateral dimensions smaller than the wavelength of light. Using this basic approach, resolution better than λ/2 has been reported. This technique also contemplates first using tapered glass pipettes and later, tapered single mode optical fibers, which made manipulating the probe in near proximity of practical (not optically flat) surfaces easier, and also took advantage of instrumentation developed for other probe microcopies, such as scanning tunneling microscopy (STM). Although the probe microscopy approaches show the ultimate potential for optical recording in terms of mark size limits, the small aperture dimensions (as small as 20-nm in diameter) do not exhibit sufficient optical throughput for practical read/write transfer rates.

An approach to near-field data storage that solves the problem of insufficient optical throughput has been reported in U.S. Pat. No. 5,625,617 entitled Near-Field Optical Apparatus With a Laser Having a Non-Uniform Emission Face, which is assigned to Lucent Technologies. In the Lucent method, the emission facet of a laser diode is altered with a focused ion beam (FIB) by removing part of an absorbing (conductive) coating to restrict lasing to a sub-wavelength sub-aperture on the emission facet. Examples of this technique have resulted in output powers of 0.6 mW at 40-mA of injection current. Although this approach shows the feasibility of flying a laser having a sub-wavelength aperture in the near-field of an optical disk, the fabrication of the submicron aperture in the laser emission facet is complicated and not easily scaled to large quantities of semiconductor lasers due to the serial nature of FIB processing. Also, the efficiency, although much improved over probe microscopy approaches, is still poor compared with unaltered semiconductor laser emission. The heat dissipation required may be significant, making a practical system utilizing a high-speed secondary actuator on the end of the slider difficult to implement. Such an actuator, by its nature, would not have very good thermal conductivity to remove heat from the semiconductor laser and conduct it to the slider suspension.

Thus there is a need for an optical storage device that provides for sub-wavelength reading/recording at sufficient throughput rates in a reading/recording head that can be easily manufactured.

### SUMMARY OF THE INVENTION

The present invention addresses the drawbacks of the prior art by providing a semiconductor laser on a flying head wherein the semiconductor laser design avoids post-processing a fully-grown laser structure (either through etching or drilling holes). Preferably, the laser is a narrow aperture buried heterojunction (NBH) semiconductor laser. An aspect of the invention is to provide a confined optical beam without the need for any external optics in order to make a low-cost head. One of the functions of conventional optical heads (CD, MO, DVD) is to shape the elliptical laser beam into a circular one. In this case, no external optics are necessary since the beam that emerges from the laser facet is circular.

The invention provides a data storage device that optically records digital data of the type accepting a removable optical storage medium. The drive has a drive mechanism for rotating said storage medium at an operational speed; an actuator assembly having an arm and a read/write head coupled to a distal end of said arm; said read/write head comprising a narrow buried heterojunction semiconductor laser, such that said arm moves said narrow buried heterojunction semiconductor laser into a near field relationship with an optical medium. The semiconductor laser produces a circular light beam that provides a circular spot on the surface of the optical medium.

One possible optical medium is that currently used in CD and DVD rewriteable discs, namely phase change material. Phase change material would also be sufficiently reflecting and absorbing at 980 nm, thus a 980-nm laser could be used in an optical storage head. Phase change material is the metal alloy such as GeSbTe or AgInSbTe whose amorphous solid phase and crystalline solid phase reflect different amounts of incident light. Phase change media is the multiple layers, including phase change, dielectric, reflecting, and hardcoat material and other layers that are necessary for wear, protection, thermal and optical management. The thickness of the other layers in the media stack (specifically the dielectric and reflecting layers) are adjusted, or “tuned,” to produce the signal modulation needed for a commercial drive.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an embodiment that is presently preferred, it being understood, however, that the invention is not limited to the specific methods and instrumentalities disclosed. In the drawings:

FIG. 1 is a top plan view of a disk drive according to the present invention;

FIG. 2A is a cross-sectional view of the area A in FIG. 1;

FIG. 2B is an isometric view of the near-field laser head of FIG. 2A;

FIG. 3 is a cross sectional view of a semiconductor laser for use in the read/write head of the present invention;

FIG. 4A is a facet of a semiconductor laser illustrating an exemplary laser emission aperture in accordance with the invention; and

FIG. 4B is a semiconductor laser chip incorporating the semiconductor laser in accordance with the invention and illustrating the emission of a circular beam.

### DETAILED DESCRIPTION OF THE INVENTION

Normally laser output profiles are elliptical in shape, described by two perpendicular diffraction angles, one parallel to the direction of growth and the other perpendicular. Typical values for the divergence of the exiting laser beam are 10 degrees and 30 degrees, respectively. However, the present invention recognizes that a semiconductor laser capable of producing an output profile that is round in shape provides advantages in data storage application, such as increased storage densities. Moreover, achieving a round output profile without the need for post process etching (i.e. to produce a waveguide) provides for a low-cost flying head laser with increased storage densities.

The present invention provides a data storage device for use with an optical medium. Throughout the description, the invention is described in connection with an exemplary optical storage device. However, many aspects of the data storage device are presented only to illustrate an operating environment for the invention. Accordingly, the invention should not be limited to the particular embodiment shown as the invention contemplates the application to other optical drive devices and configurations.

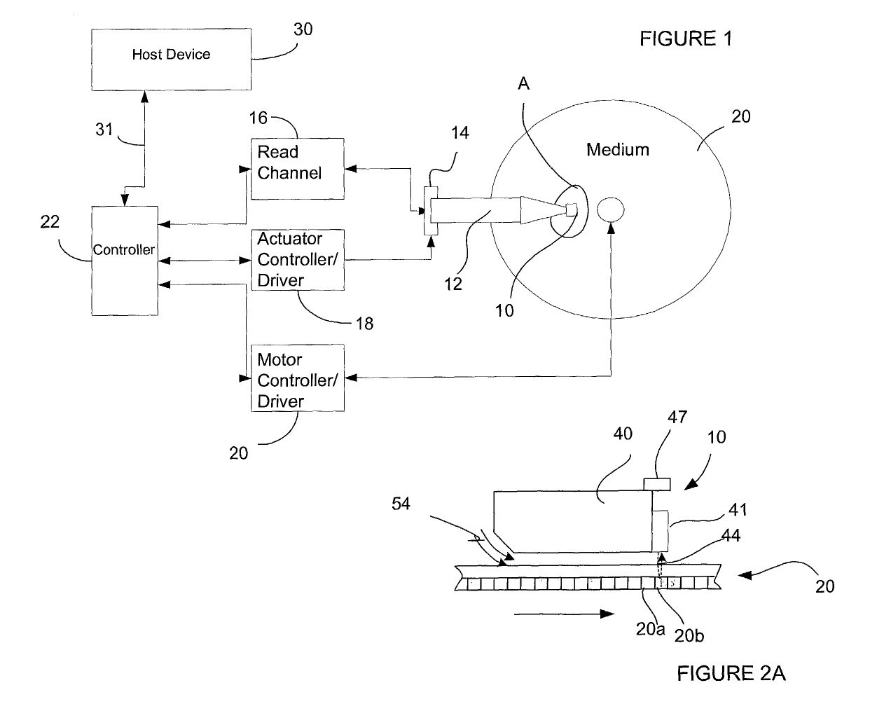

FIG. 1 is a top view of an optical storage drive for storing and retrieving information for a host device. Host device 30 is one of a number of computer based devices such as a personal computer, a handheld computer, or the like. Host device 30 communicates with optical drive 40 via bus 31 by sending commands to write or read digital information to or from optical medium 20. Optical drive 40 comprises a controller 22 that provides an interface with host device 30 as well as controlling the operation of optical drive 40. Optical drive 40 also comprises a read channel 16 for conditioning signals read from optical medium 20; actuator controller 18 for providing servo control and tracking; motor controller 20 for controlling the spin rate of optical medium 20, and an actuator assembly for reading the data from the medium 20.

The optical medium may be either rigid or flexible. Moreover, the medium may be write-once ablative, write-once phase change, write-once dye polymer, and rewriteable phase change. Any material with a sufficient absorption coefficient at the laser emission wavelength can be considered for the optical storage medium. Phase change material would also be sufficiently reflecting and absorbing at 980 nm, thus a 980-mn laser could be used in an optical storage head. Phase change material is the metal alloy such as GeSbTe or AgInSbTe whose amorphous solid phase and crystalline solid phase reflect different amounts of incident light. Phase change media is the multiple layers, including phase change, dielectric, reflecting, and hardcoat material and other layers that are necessary for wear, protection, thermal and optical management. The thickness of the other layers in the media stack (specifically the dielectric and reflecting layers) would have to be adjusted, or “tuned,” to produce the signal modulation needed for a commercial drive.

The actuator assembly comprises a read/write head 10 that is connected to a distal end of an actuator assembly. The actuator assembly also comprises a suspension arm 12 and an actuator 14 that cooperate to move the optical head 10 over the surface of medium 20 for reading and writing digital information. The actuator assembly may be linear (i.e. wherein the head moves along a radian from the outer diameter to the inner diameter or the medium) or rotary wherein the head moves in a arc across the medium.

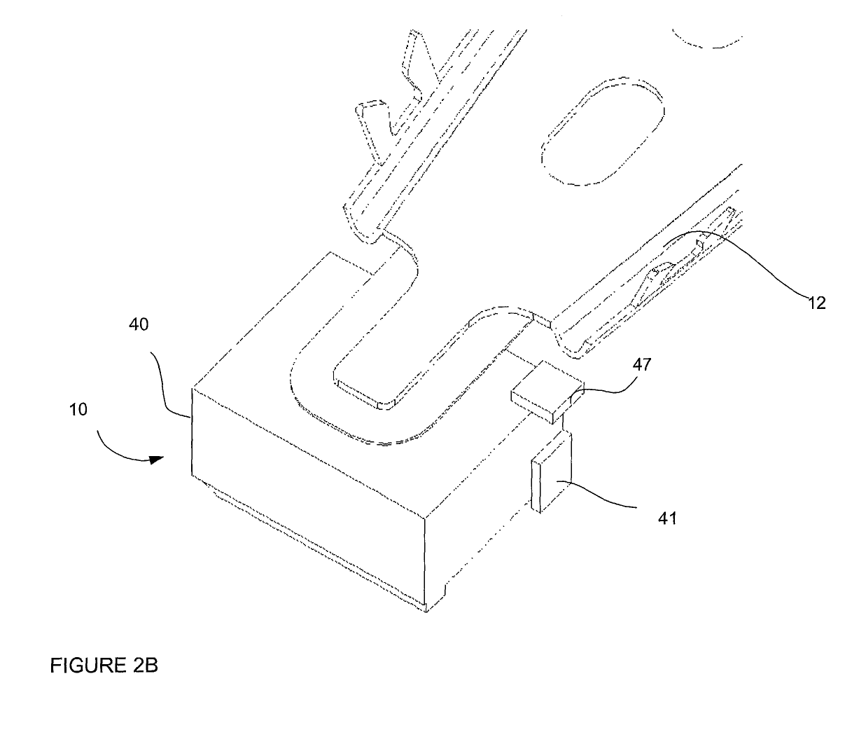

FIG. 2A is a cut-away view taken about section A of FIG. 1 and further illustrates aspects of read/write head 10 in accordance with the present invention. FIG. 2B is an isometric view of read/write head 10 mounted to suspension arm 12. The read/write head comprises a slider 40 that “flys” over the surface of medium 20 on air bearing that is generated by air flow 54 that is forced under slider 40 by the movement of medium 20 past slider 40. A laser chip 41 having a laser diode and a photodetector 47 is mounted to the back portion of the slider. The laser chip has a back facet (opposite to 44) that has a highly reflective coating and a front facet 44 that has a low-reflecting coating. The low reflective coating is commonly called an anti-reflection coating. A small portion of the laser power exits the back facet and is incident upon the photodetector. A larger portion of the laser power exits the front facet 44 and is incident upon the medium 20. Laser chip 41 reflects a light beam 44 off of the surface of medium 20 to read bits of information (20a, 20b) or write bits of information (20a, 20b). For example, light reflected by bit 20a is interpreted as a digital “zero” bit, and light reflected by bit 20b is interpreted as a digital “one” bit. Because the medium has a reflectivity higher than the front facet of the laser, the reflected light strongly effects the amount of optical feedback in the laser cavity. This changes the amount of output power from the back facet of the laser diode (opposite surface to 44) that is sensed by the photodetector. The photodetector 47 is chosen so that is sensitive to the wavelength of the light emission characteristic of the laser diode. In this embodiment, the photodetector is made of silicon but could also be made primarily of InGaAs or some other light-sensitive material. In a different detection method example, the voltage across the laser diode could be sensed as the feedback to the laser changes, obviating the need for a photodetector. To write a bit of information to medium 20, laser chip 41 emits a light beam to change the phase of medium 20 between the state 20a to state 20b and vice-versa.

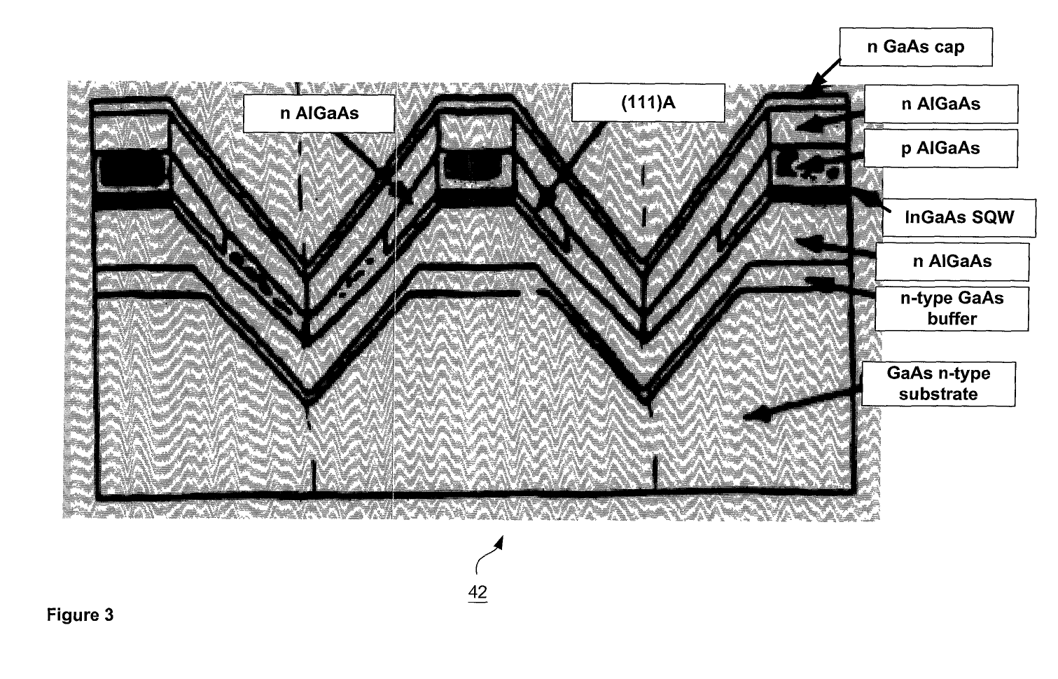

FIG. 3 illustrates a cross-section of a preferred embodiment of laser diode 42. Preferably, laser diode 42 is a narrow aperture buried heterojunction (NBH) semiconductor laser. Such laser is described in detail in H. Zhao et al. in IEEE Journal of Quantum Electronics, Vol. 1(2), pp. 196-202. Such lasers can be fabricated using conventional lithography having lateral emitting dimensions as small as 0.3 μm. The fabrication process requires only readily-available lithography technology for beginning features on the order of 2-3 μm, with smaller features formed by selective etching of the patterned substrate and well-understood epitaxial growth methods for III-V materials. The growth sequence of the laser diode 42 comprises a 4000 Å n-GaAs buffer layer and a 1.5 μm n-Al_{0.6}Ga_{0.4}As bottom n-cladding preferably grown at about 830° C. The 80 ÅIn_{0.28}Ga_{0.75}As quantum well is grown at 640° C. The temperature is increased to 800 ° C. during the growth of the GaAs layer adjoining the quantum well and the remainder of the waveguide layer, and approximately 5000 Å of the AlGaAs top cladding layer are

grown at 800° C. This portion of the cladding layer is counter doped with Si to enhance the n-type selective doping on the (111)A sidewall. The doping level is low compared to the p-type background (due to carbon) incorporated on the surface, so that the carrier concentration of the materials on the facet is changed by only a few percent. After this layer, the temperature is decreased to 700° C. for the growth of n-type doped Al_{0.6}Ga_{0.4}As upper cladding layer. Finally, a 2000 Å undoped GaAs cap layer is grown at 630° C.

NBH lasers were developed for efficient and low-cost fiber coupling of semiconductor lasers and laser arrays. Due to their structure, they exhibit threshold currents less than 1 mA and wallplug efficiencies greater than 50%. These lasers also exhibit linear L-I curves, and single spatial mode behavior up to 50-mA of drive current, and have demonstrated powers as high as 45 mW. Because laser of FIG. 3 requires such low threshold current to begin lasing and is highly efficient, laser can be mounted on small cross-sectional disk head suspension and high-speed secondary actuators, which are essential for high radial density track following. For example, head 10 of FIG. 2 can have a width of about 0.04 inches, preferably about 0.039 inches.

Moreover, as a result of the temperature performance of laser 42, drive 40 will also exhibit good temperature performance, having characteristic temperature T₀ ranging from about 100-170 K. This high T₀ means that the drive head will operate at temperatures as high as 100_C, which far exceeds the operating temperature of the highest-performing commercial disk drives, optical or otherwise. Moreover, the drive will have a 3 dB bandwidth of 10 Ghz, supporting digital modulation at 2 GB/s.

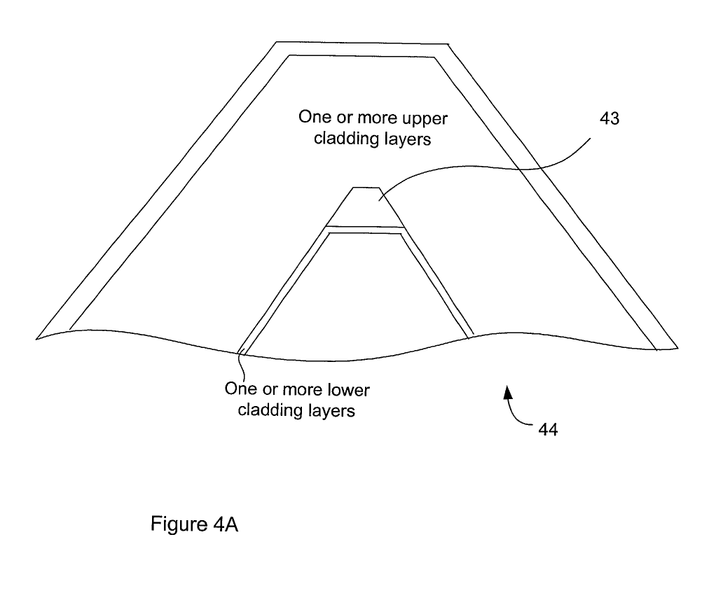

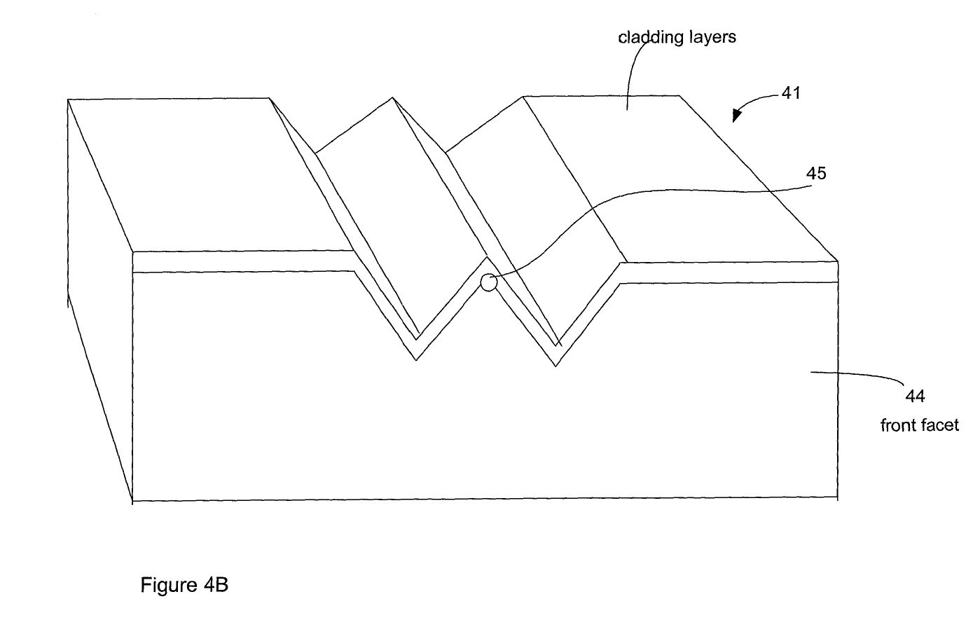

FIG. 4A and B are illustrations of an uncoated laser facet (FIG. 4A) and an laser chip (FIG. 4B) that incorporates the facet of FIG. 4A that illustrate further aspects of laser diode 42. Laser chip 41 is a chip fabricated substantially in accordance with and in accordance with an aspect of laser diode 42 described more fully in connection with FIG. 3 above. Laser chip 41 has a laser facet 44 emitting a light beam 45 from a laser emission aperture 43. Here, laser chip 42 is energized at a current level just below the lasing threshold. As a result, the light beam 45 is round and illustrates a significant aspect of the invention. Round spatial beam profiles are expected from rectangular and trapezoidal (43) emission apertures. The material index difference between the waveguide (43) and the cladding layers, grown just below and just above the waveguide, is sufficient to confine the electromagnetic field substantially within the waveguide, but some of the field will exist in the cladding layers. The result of this is a round, rather than trapezoidal beam emission profile. Additionally, small variations in the width of the trapezoidal waveguide base, as expected from normal manufacturing process variations, will not significantly alter the resultant beam emission profile.

Referring back to FIG. 2, a laser chip that produces a round spot, such as laser chip 42 is incorporated into flying head 40

Data detection is achieved by monitoring the optical feedback that varies as the contrast or depth of written data marks varies by exploiting the Optically Switched Laser (OSL) method. The detection method of OSL is well suited for write-once or rewriteable optical media in which the contrast of the media is changed by varying the laser write power. These media types include disks, write-once ablative, write-once phase change, write-once dye-polymer, and rewriteable phase change, at a minimum.

Currently, the highest-performance rewriteable optical storage media is magneto-optical (MO) media. MO media is an amorphous rare earth-transition metal alloy that exhibits perpendicular anisotropy of the magnetization vector. Data is encoded in binary “1”s and “0”s by the orientation of the magnetic dipole. In conventional MO storage, linearly polarized light that is reflected from the written marks is rotated either clockwise or anticlockwise depending on the orientation of the dipole. This rotation is due to the Kerr effect, and is small, usually on the order of 0.5_. MO drives have costly polarization-sensitive elements to detect this small rotation in the data detection/servo detection path.

A more straight-forward detection mechanism could also be exploited by a hybrid approach that combines a near-field sub-wavelength aperture flying semiconductor laser to thermally write MO marks in conjunction with a small electromagnetic coil to orient the magnetic dipole as the magnetic domain cools, and an additional thin film, magneto-resistance (MR) head, or giant magneto-resistance (GMR) head integrated with the laser to read the MO domains by inducing a current in the magnetic read heads as they fly over the MO magnetic domains.

The above description of preferred embodiments is not intended to impliedly limit the scope of protection of the following claims. Thus, for example, except where they are expressly so limited, the following claims are not limited to applications involving optical disk drive systems, but may apply to other drive systems such as magneto-optical.

What we claim is:

1. An optical information storage apparatus, comprising:
an actuator arm movably coupled within said optical information storage apparatus;
a narrow buried heterojunction semiconductor laser coupled to a distal end of said actuator arm, wherein the semiconductor laser provides a confined optical beam without the need for any external optics, said actuator arm moving said narrow buried heterojunction semiconductor laser into a near field relationship with an optical medium; and
a motor for spinning said optical medium at an operational speed.

2. The optical information storage apparatus as recited in claim 1 wherein said narrow buried heterojunction semiconductor laser comprises an emission facet formed therein such that said laser can perform near field optical recording with wavelength-independent resolution on said optical medium.

3. The optical information storage apparatus as recited in claim 1 wherein said optical medium comprises a rigid medium.

4. The optical information storage apparatus as recited in claim 1 wherein said optical medium comprises a flexible medium.

5. The optical information storage apparatus as recited in claim 1 further comprising a slider coupled to said distal end of said arm, said semiconductor laser being fixed to said slider so that said semiconductor laser flys over said optical medium on an air bearing.

6. The optical information storage apparatus as recited in claim 5 wherein said semiconductor laser is fixed to a back end of said slider.

7. The optical information storage apparatus as recited in claim 5 wherein said semiconductor laser is monolithically integrated in said slider.

8. The optical information storage apparatus as recited in claim 1 wherein a photo sensitive element is attached to said slider in a location directly behind the back facet of the narrow buried heterojunction semiconductor laser;

9. The optical information storage apparatus as recited in claim 8 wherein said photo sensitive element is a semiconductor photodetector;

10. The optical information storage apparatus as recited in claim 9 wherein said photodetector is primarily comprised of silicon.

11. The optical information storage apparatus as recited in claim 1 wherein said semiconductor laser comprises a threshold current of less than about 5 mA.

12. The optical information storage apparatus as recited in claim 1 wherein said semiconductor laser comprises a lateral emitting dimensions less than about 0.3 μm.

13. The optical information storage apparatus as recited in claim 1 wherein said optical beam emitted from the semiconductor laser is essentially circular in cross section.

14. The optical storage information storage apparatus as recited in claim 9 wherein the a laser spot is produced on a surface of the medium that is substantially round.

15. The optical storage information storage apparatus as recited in claim 1 wherein the detection method comprises a signal change in the photo sensitive element proportional to the laser back facet power.

16. The optical storage information storage apparatus as recited in claim 1 wherein the detection method comprises of monitoring the voltage change across the semiconductor laser diode.

17. A drive for optically recording digital data of the type accepting a removable optical storage medium, said drive comprising:
a drive mechanism for rotating said storage medium at an operational speed;
an actuator assembly having an arm and a read/write head coupled to a distal end of said arm;
said read/write head comprising a narrow buried heterojunction semiconductor laser, wherein said semiconductor laser emits a confined optical beam without the need for any external optics, said arm capable of moving said narrow buried heterojunction semiconductor laser into a near field relationship with an optical medium

18. The drive as cited in claim 17 wherein a photo sensitive element is attached to said head in a location directly behind the back facet of the narrow buried heterojunction semiconductor laser;

19. The drive as cited in claim 18 wherein said photo sensitive element is a semiconductor photodetector;

20. The drive as cited in claim 19 wherein said photodetector is primarily comprised of silicon.

21. The drive as recited in claim 17 wherein said head is about 0.039 inches wide.

22. The drive as recited in claim 17 wherein said actuator assembly comprises a linear actuator for moving said arm linearly across a surface of said optical storage medium.

23. The drive as recited in claim 17 wherein said medium comprises one of write-once ablative, write-once phase change, write-once dye polymer, and rewriteable phase change.

24. The drive as recited in claim 17 wherein said head comprises a slider to which said semiconductor laser is attached for flying the semiconductor laser over a surface of said optical storage medium on an air bearing.

25. The drive as recited in claim 17 wherein said medium comprises on of a flexible and a rigid medium.

26. The drive as recited in claim 17 wherein the semiconductor laser produces a substantially circular spot on the optical storage medium.

27. The drive as recited in claim 17 wherein the optical beam has a circular cross section.

28. An optical storage information storage apparatus, comprising:
an actuator arm movably coupled within said optical information storage apparatus;
a narrow buried heterojunction semiconductor laser coupled to a distal end of said actuator arm, wherein the semiconductor laser provides a confined optical beam without any need for external optics;
an electromagnetic coil additionally coupled to a distal end of said actuator arm, wherein the electromagnetic coil is in proximity to said semiconductor laser;
said actuator arm moving said narrow buried heterojunction semiconductor laser into a near field relationship with an optical medium;
a magnetically sensitive read element is additionally coupled to a distal end of said actuator arm; and
a motor for spinning said optical medium at an operational speed.

29. The optical storage information storage apparatus as recited in claim 24 wherein said optical medium is magneto-optical in nature,

30. The optical storage information storage apparatus as recited in claim 24 wherein said magnetically sensitive read element is a giant magneto resistive head.
